(19) United States
(12) Patent Application Publication
(10) Pub. No.: US 2019/0327957 A1
(43) Pub. Date: Oct. 31, 2019

(54) DECOY SURFACE AREA ILLUMINATION APPARATUS AND METHODS

(71) Applicant: Paul Wessel, New Ulm, MN (US)

(72) Inventor: Paul Wessel, New Ulm, MN (US)

(21) Appl. No.: 16/394,912

(22) Filed: Apr. 25, 2019

Related U.S. Application Data
(60) Provisional application No. 62/662,406, filed on Apr. 25, 2018.

(51) Int. Cl. A01M 31/06; F21V 23/04; F21V 33/00

(52) U.S. Cl. CPC A01M 31/06; F21V 33/008; F21V 23/0464

(57) ABSTRACT

A hollow body, head, or any operable combination thereof, visually representing the shape of an animal or bird, comprising an internally or externally located electronic programmable light source that when illuminated projects light to at least one specific surface area of body or head.

### RELATED APPLICATION

The present application claims the benefit of U.S. Provisional Application No. 62/662,406 filed Apr. 25, 2018, which is hereby incorporated herein in its entirety by reference.

### TECHNICAL FIELD

In general, the present disclosure relates to duck and goose decoys. More particularly, the present disclosure relates to different parts of the decoy head and or body with internal electronic light source circuitry that illuminates outer surface areas of the decoy to make them more visible to waterfowl in low-light conditions.

### BACKGROUND

In the world of hunting the use of decoys is often used to attract incoming wildlife into shooting range of the hunter. The history of using wildlife decoys can be traced back to early civilizations and have evolved so that today these decoys appear nearly lifelike.

There are basically four main methods of increasing light reflectivity to any surface area—increase the output of the light source directed at the surface area, change the reflective properties of the material surface area, illuminate the surface area with multiple sources located in different axial positions directed at the surface area, or covering the surface area with an additional coating to the surface areas that enhances the reflective properties of the surface area.

Most illumination methods relating to the hunting or fishing industry are firstly derived from fishing lures, where prior art describes apparatus and methods of internal light generation from the hollow cavity of a fishing lure and projects small amounts of light outward to simulate the “flash” of a bait swimming in the water as described in Hawryshyn et al. in U.S. Pat. No. 8,204,078. Yu in U.S. Pat. No. 6,922,935 and Garr in U.S. Pat. No. 4,888,905 claim different methods of adjusting light levels or changing colors, generated inside the hollow cavity of a fishing lure, through electronic control circuitry that detects and adjusts for varying murky water conditions.

As it pertains specifically to decoys and even more specifically waterfowl decoys, much of the prior art deals with changing or modifying the reflective properties on the surface area of the waterfowl decoy. Johnson et al. U.S. Pat. No. 8,650,975 claims methods for creating a surface coating for use on a model of an animal and subsequently claims methods for detecting and analyzing reflective properties for different wavelengths of surface coatings. Pringle et al. in U.S. Pat. No. 9,149,033 claims methods for creating camouflage coverings using compositions that take into consideration specific reflective properties that create an optical advantage of being detected by wildlife.

One of the major challenges still to overcome, especially by waterfowl and deer hunters, is the decoy's realism in low-level light conditions, i.e. very early morning or cloudy days, approximately 200-10,000 lux.

One method of adjusting to these low level conditions has been to change the outer surface cover material of different decoy body parts to reflect more light during sunny light conditions when ambient outdoor light levels range from approximately 30,000-120,000 lux. However, this combination of reflective decoy material and sunlight does not work with low light levels or cloudy conditions.

### SUMMARY

A hollow body, head, or any operable combination thereof, visually representing the shape of an animal or bird, comprising an internally or externally located electronic programmable light source that when illuminated projects light to at least one specific surface area of body or head.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1—is perspective drawing of a waterfowl decoy head illustrating light generation and transmission to at least one part of its surface area.

FIG. 2—is perspective drawing of a waterfowl decoy body illustrating internal light generation and transmission to at least one part of its surface area.

FIG. 3—is a block diagram of programmable electronic light source components.

FIG. 4—is a perspective drawing of a remotely powered light source in operable combination with electronic programmable control circuitry in further operable combination with a current-carrying material that connects remotely powered light source with electronic programmable control circuitry.

FIG. 5—are perspective top and side views of a waterfowl decoy of at least one surface area being illuminated by an externally focused light source to increase visibility of existing of at least one part of the surface area.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

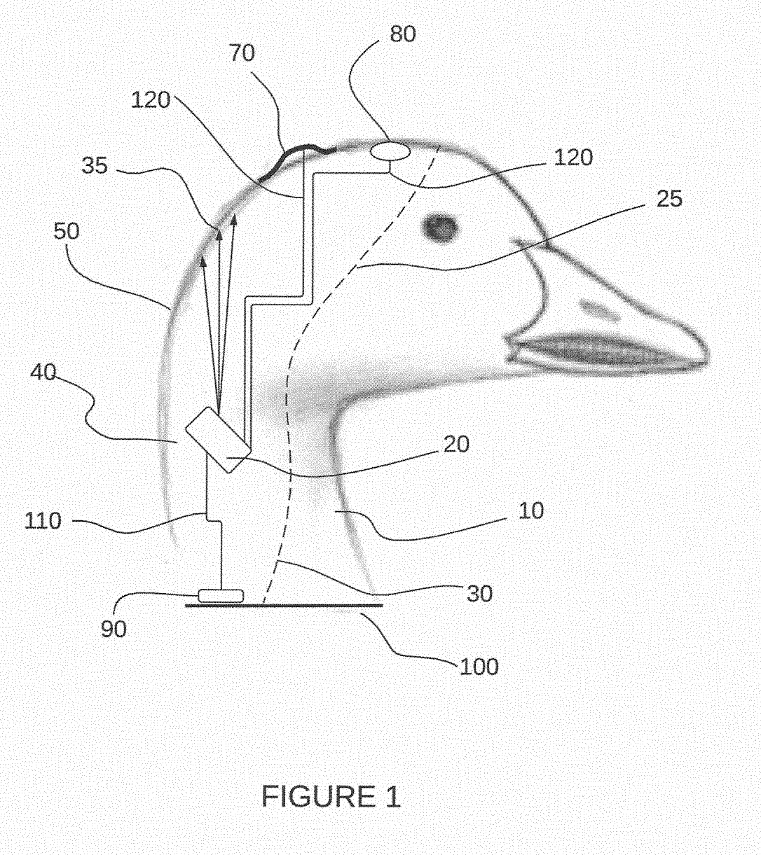

Referring to FIG. 1, an exemplary embodiment of a waterfowl decoy head 10 is shown. It will be understood that the size and shape of waterfowl decoy head can vary widely dependent upon the geographic region and the type of waterfowl being sought. The shown embodiment 10 is meant to be indicative of all types of waterfowl decoy heads, regardless of size and shape.

The waterfowl decoy head 10 can have an internal, hollow chamber 40 exemplary defined by 30, constructed of a material capable of internally reflecting light 35 that has been generated by a programmable, electronically powered light source 20, which is further externally controlled by an on/off watertight pushbutton switch 70 located on an external portion of the decoy head 10 that allows or prevents the electrical power from being applied to light source 20. The programmable, electronic light source can also receive electronic light adjustment information from an ambient light detector 80 that is capable of detecting and communicating at least one ambient light value via communications element 120 to programmable, electronically powered light source 20.

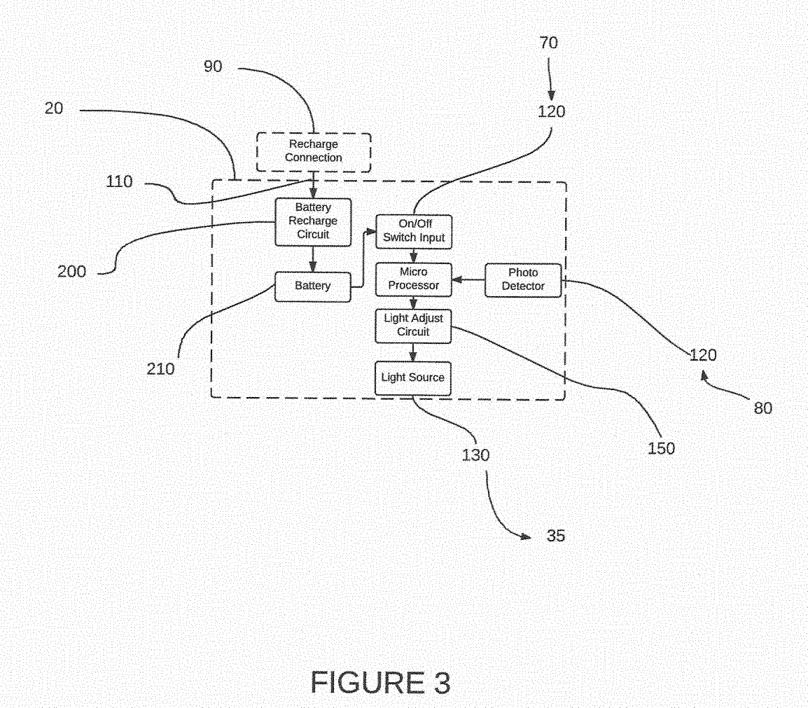

The waterfowl decoy head 10 may also contain a watertight connector 90 that is capable of receiving an electronic connector that carries electric current 110 to light source 20 to recharge a battery 200, 210 of the programmable, electronically powered light source 20 (See FIG. 3).

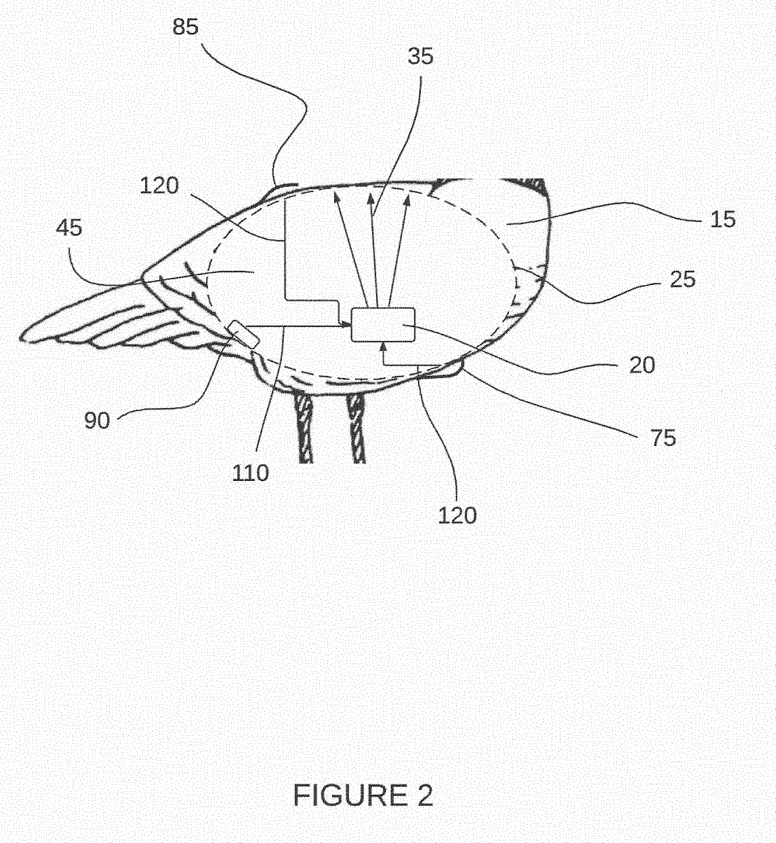

Referring to FIG. 2, an exemplary embodiment of a waterfowl decoy body 15 is presented. It will be understood that the size and shape of waterfowl decoy body can vary widely dependent upon the geographic region and the type of waterfowl being sought. The shown embodiment 15 is meant to be indicative of all types of waterfowl decoy heads, regardless of size and shape.

The waterfowl decoy body 15 also has an internal, hollow chamber 45 exemplarily defined by 25, constructed of a material capable of internally reflecting light 35 that has been generated by a programmable, electronically powered light source 20, which is further externally controlled by an on/off watertight pushbutton switch 75 located on an external portion of the decoy body 15 that allows or prevents the electrical power from being applied to light source 20. The programmable, electronic light source can also receive electronic light adjustment information from an ambient light detector 85 that is capable of detecting and communicating at least one ambient light value via communications element 120 to the programmable, electronically powered light source 20.

The waterfowl decoy body 15 may also contain a watertight connector 90 that is capable of receiving an electronic connector that carries electric current 110 to 20 to recharge a battery 200, 210 of the programmable, electronically powered light source 20 (See FIG. 3).

Referring to FIG. 3 is an electrical block diagram of the programmable, electronically powered light source 20 is shown. Light source 20 can include a microprocessor that controls the operations of the other components of light source 20. Switch 70 or 75 is functionally linked to microprocessor such that activation or deactivation of switch causes the light source 20 to turn on or off. Microprocessor can receive ambient light information from the ambient light detector 80 or 85 and use a light adjusting circuit 150 to adjust the amount of light provided to a remote light source 130 based on the ambient light information. Microprocessor can receive power from batter 210 having a battery recharge circuit 200 connectable to a power source with connector 90.

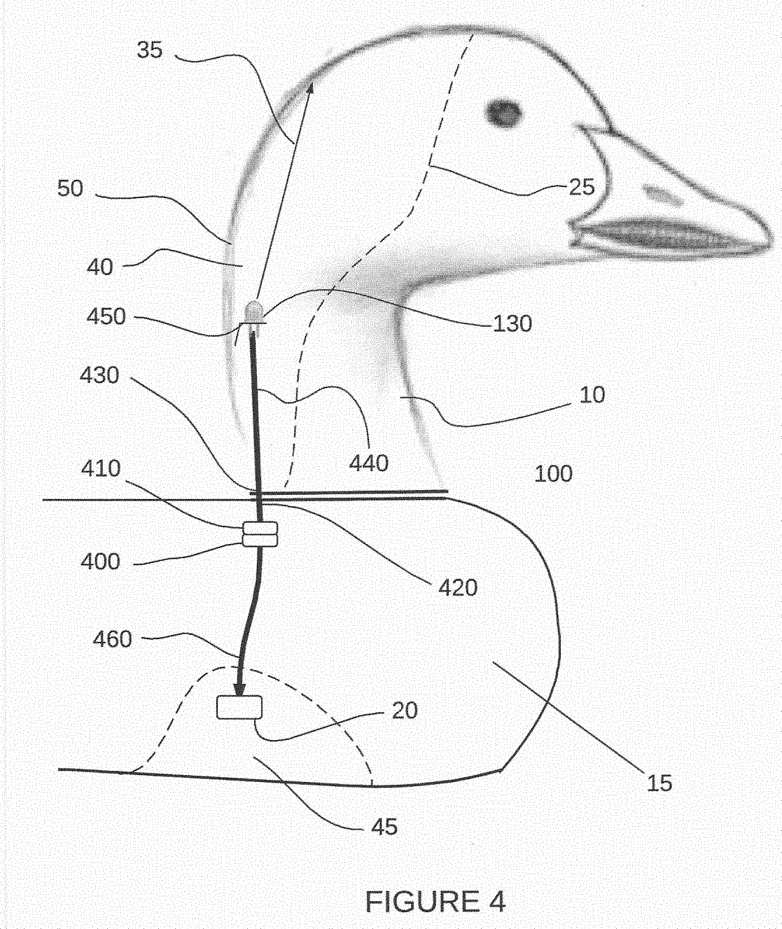

Referring to FIG. 4, a distributed configuration of the programmable, electronically powered light source 20 is shown where the programmable, electronically powered light source 20 is positioned and held within at least one hollow portion of the decoy body 15 from which it is operably connected to a hardwired, electrical means of carrying electronic current, either directly or through an electrical connector configuration 460, 400, 410, 440, to provide at least a minimal amount of current sufficient to illuminate a remotely placed electronic light source 130, that has been affixed with a connector 450 to provide illumination 35 to the surface area of the decoy head 50.

While FIG. 4 illustrates the combination wherein programmable light source 20 is located within a hollow portion of the decoy body 15 and then electronically operates a remotely-located light source 130, affixed to at least one hollow portion 40 of the decoy head 10, multiple and varied combinations of where the combination of programmable light source 20 and remotely located light source 130 are placed within decoy head 10 and decoy body 15 are also contemplated.

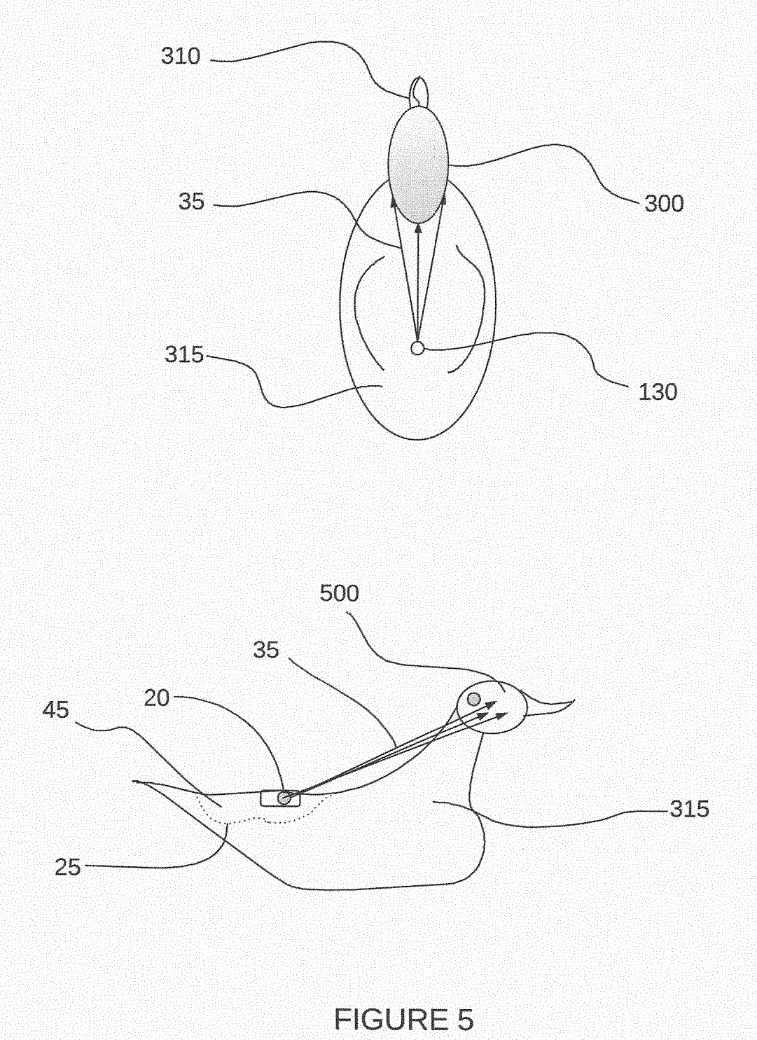

Referring to FIG. 5 an alternate method of illuminating or enhancing at least one surface area of a waterfowl decoy head 300 or body 315 with a programmable light source 20 externally located and affixed in at least one axial location 130 so as to direct illumination 35 to at least one surface area of waterfowl decoy head 300 or decoy body 315 is depitcted.

While FIG. 5 illustrates the placement of at least one portion of programmable light source 20 is placed outside 130 of at least one surface area of the body 315 and provides direct illumination 35 to the decoy head 300, multiple configurations and axial placements of 20, 130 are contemplated, including, for example, placement on the decoy head 300 with illumination 35 directed towards the body 315 or a combination of placement on both the decoy head 300 and body 315 with illumination directed towards the other component.

While FIG. 5 is an exemplary illustration of direct illumination methods it is also contemplated that to achieve an optimum visual decoy representation that the use of multi colored or filters are also contemplated.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A wildlife decoy comprising:
a body defining a generally hollow compartment of at least partially translucent material visually resembling at least one part of a body shape and size of one species of wildlife;
a head defining a generally hollow compartment of at least partially translucent materially visually resembling at least one part of a head shape and size of the one species of wildlife,
wherein an assembled operable combination of the body and the head visually resembles at least one species body and head shape and size of the one species of wildlife; and
programmable electronic light control circuitry including—
a light source;
an electrical power source;
a control element configured for programming and causing projection light intensity levels to at least 10,000 lumens by the light source; and
a means for detecting ambient outdoor light conditions from at least 200 lumens.

2. The wildlife decoy of claim 1, wherein the control element is configured to receive ambient light information from the means for detecting ambient outdoor light conditions and to automatically adjust the light intensity level of the light source based on the ambient light information.

3. The wildlife decoy of claim 1, wherein the light source is disposed within the generally hollow compartment of the body.

4. The wildlife decoy of claim 1, wherein the light source is disposed within the generally hollow compartment of the head.

5. The wildlife decoy of claim 1, wherein the light source is disposed on an exterior of the body.

6. The wildlife decoy of claim 5, wherein the light source is positioned on the exterior of the body to project light onto the head.

7. The wildlife decoy of claim 1, wherein the light source is disposed on an exterior of the head.

8. The wildlife decoy of claim 7, wherein the light source is positioned on the exterior of the head to project light onto the body.

9. The wildlife decoy of claim 1, wherein the electrical power source of the programmable electronic light control circuitry is a rechargeable battery.

10. The wildlife decoy of claim 1, further comprising;
at least one type of exterior coating of colored absorption material applied to at least one part of the surface area of the body in operable combination with a light intensity level of at least 10,000 lumens provided by the light source.

11. The wildlife decoy of claim 1, further comprising a push button switch disposed on an exterior of the head or the body, wherein the push button switch is configured to cause the control element to turn the light source on an off.

12. The wildlife decoy of claim 11, wherein the push button switch is disposed on the exterior of the body.

13. The wildlife decoy of claim 11, wherein the push button switch is disposed on the exterior of the head.
